(19) United States
(12) Patent Application Publication
(10) Pub. No.: US 2013/0106570 A1
(43) Pub. Date: May 2, 2013

(54) SECURITY SYSTEM AND METHOD

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/474,740

(22) Filed: May 18, 2012

(30) Foreign Application Priority Data
Oct. 27, 2011 (TW) 100139017

(51) Int. Cl. G06F 7/04

(52) U.S. Cl. 340/5.54

(57) ABSTRACT

A security system includes an input unit, a storage unit, and a comparing unit. The user may input a password by means of the input unit. The comparing unit compares the inputted password with a predetermined password stored in the storage unit to check for a match. In addition, the stroke order information of the two passwords can be further compared. Thereby, the comparing unit determines to unlock the lock unit or not. The disclosure further provides a security method.

### BACKGROUND

1. Technical Field

The present disclosure relates to a security system and a security method, and particularly to a door security system and a door security method for unlocking a door without a key or a card.

2. Description of Related Art

If a key or a card is utilized as an instrument for opening a door or doors, users having a need to unlock or lock the door or doors must carry around the key or the card to perform the unlocking or locking of the door or doors. The key or the card may be lost or stolen and this is inconvenient.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of a first embodiment of a security system of the present disclosure.

FIG. 2 is a block diagram of a second embodiment of a security system of the present disclosure.

FIG. 3 is a block diagram of a third embodiment of a security system of the present disclosure.

FIGS. 4-8 are the operating diagrams of the security system in FIG. 3.

FIG. 9 is a flowchart of an embodiment of a security method of the present disclosure.

### DETAILED DESCRIPTION

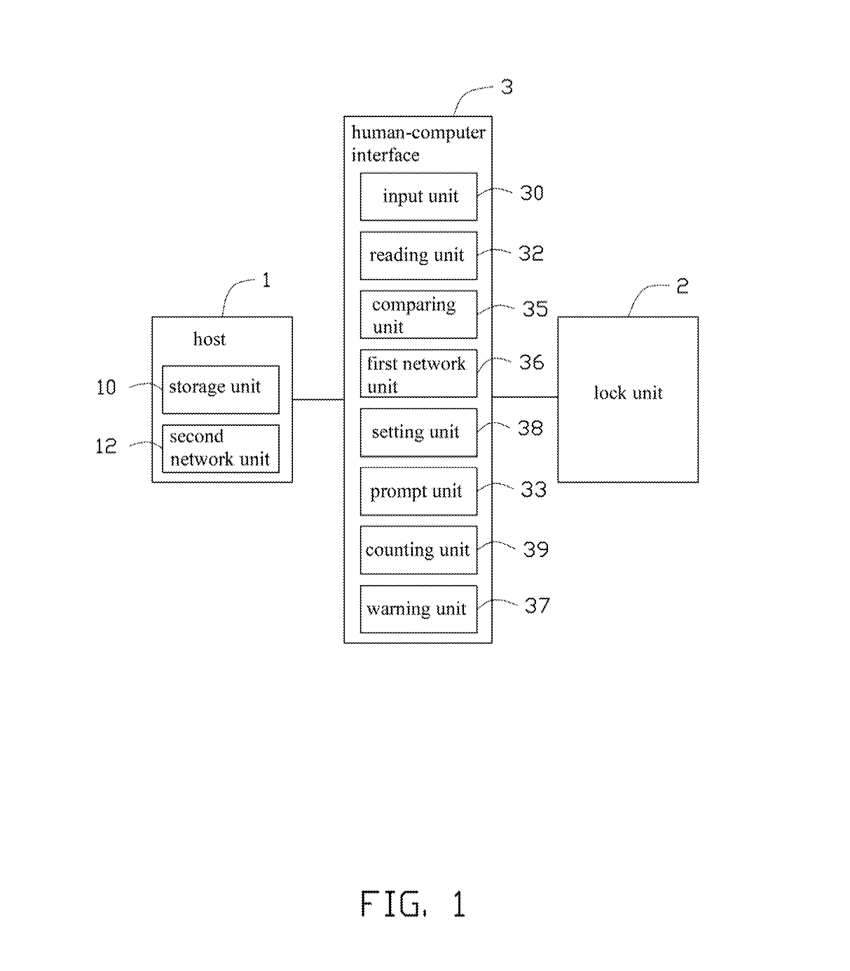

As shown in FIG. 1, a first embodiment of a security system includes a host 1, a lock unit 2 and an operating device, wherein a human-computer interface 3 is used as the operating device in this embodiment. The host 1 can be installed in the user's house and utilized to store the password set by the user. The lock unit 2 is utilized to lock or unlock a door, such as the front door, of the house. The human-computer interface 3 can be installed near the outside of the door and utilized to receive input from the user and to transmit control signals to control the security system.

The human-computer interface 3 includes an input unit 30, a reading unit 32, a comparing unit 35, a first network unit 36, a setting unit 38, a prompt unit 33, a counting unit 39 and a warning unit 37. In the embodiment, the input unit 30 can be a touch screen. The setting unit 38 is utilized to choose a mode of the security system. The mode of the security system includes a security authentication mode and a security setting mode. When the user selects the security setting mode, the user can set a predetermined password by means of the input unit 30. In the embodiment, the predetermined password includes a first content information. In an embodiment, the password can be set arbitrarily by the user so that the first content information of the predetermined password can be a letter, a symbol, a word, a character, a drawing or a combination thereof. In an embodiment, the predetermined password further includes a first stroke order information.

The host 1 includes a storage unit 10 and a second network unit 12. The storage unit 10 is utilized to store the predetermined password which has been inputted. The second network unit 12 is utilized to communicate with the first network unit 36 of the human-computer interface 3 so that the human-computer interface 3 and the host 1 can communicate with each other.

When the user selects the security authentication mode, the user can input a password. In the embodiment, the inputted password in the security authentication mode also includes a second content information which can be a letter, a symbol, a word, a character, a drawing or a combination thereof. In an embodiment, the inputted password further includes a second stroke order information. The inputted password inputted by the user is transmitted to the comparing unit 36. At that time, the reading unit 32 reads the predetermined password stored in the storage unit 10. Then, the comparing unit 35 compares the inputted password with the predetermined password to check whether the inputted password is identical with the predetermined password. In an embodiment, the comparing unit 35 checks whether or not the second content information and the second stroke order information are respectively identical with the first content information and the first stroke order information. When the content information and the stroke order information of the inputted password match the content information and the stroke order information of the predetermined password, the comparing unit 35 transmits a first control signal to the lock unit 2 for unlocking the lock unit 2. Then, the door can be opened.

When the first and the second content information are different or the first and the second stroke order information are different, the comparing unit 35 transmits a second control signal to the prompt unit 35 to prompt the user that the inputted password inputted by the user is wrong and that another password should be inputted again. In the embodiment, the prompt unit 35 can prompt the user by showing or directly telling the user about the error. At the same time, the counting unit 39 counts the number of times that an attempt is made to input a password, i.e. the number of the second control signals transmitted by the comparing unit 35. When the number of attempts is larger than a predetermined number, such as three times, a third control signal is transmitted to the warning unit 37. The warning unit 37 then reports a security situation to the security guard of the house or to the user and the security guard at the same time. Thereby, the security guard may check the door due to the security situation. In an embodiment, the warning unit 37 can ring an alarm bell or send a message by the first or the second network units 12 and 36.

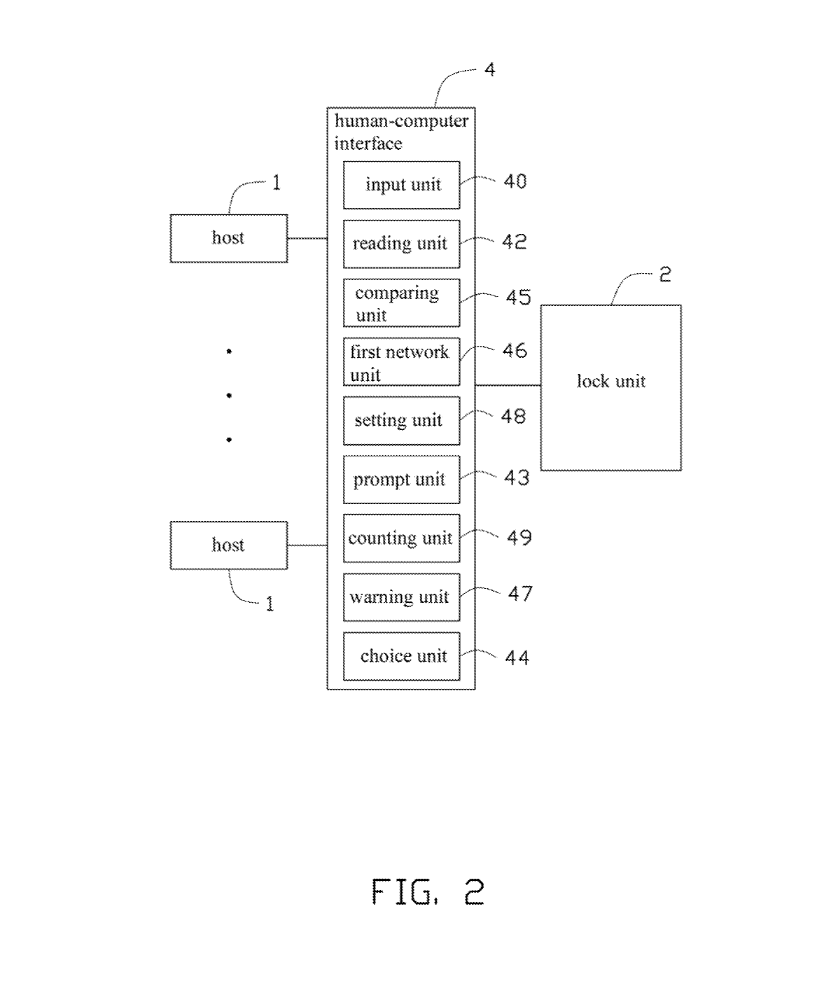

In the above embodiment, the security system includes only a host 1 if there is only a user living in the house. Therefore, the predetermined password is directly stored in the storage unit 10 of the host 1 when the user sets the predetermined password in the security setting mode. In another embodiment, the security system of the disclosure can be installed in a very large building used for residential accommodation, such as an apartment complex or a condominiums, so that there are many users living or working in the building. Therefore, the building, i.e. the security area of the security system, can include a plurality of controlled areas in a second embodiment of the security system, wherein the plurality of controlled areas corresponding to a plurality of housing or storage units are separated according to the rights of the users. Thus, a human-computer interface 4 of the security system in the second embodiment further includes a choice unit 44 for selecting one of the storage units. In addition, the human-computer interface 4 also includes an input unit 40, a reading unit 42, a comparing unit 45, a first network unit 46, a setting unit 48, a prompt unit 43, a counting unit 49 and a warning unit 47. The functions of the input unit 40, the reading unit 42, the comparing unit 45, the first network unit 46, the setting unit 48, the prompt unit 43, the counting unit 49 and the warning unit 47 are the same as the functions of the corresponding units in the first embodiment. When one of the users tries to set the predetermined password in the security setting mode, this user should be identified by the security system. In other words, the number or designation of the controlled area, such as the number of the house or room, should first be established or selected by the choice unit 44 for identifying the user first so that the correct housing or storage unit is also selected. Accordingly, the predetermined password can be stored in the corresponding housing or storage unit. In this way, the user can input his/her password to compare with the predetermined password stored in the corresponding housing or storage unit of the selected controlled area for unlocking the lock unit 2 to open the door of the common or central security area, such as the main entrance of the building. In the embodiment, the selected housing or storage unit can be included in the host 1 installed in the house or room of the user, as shown in FIG. 2.

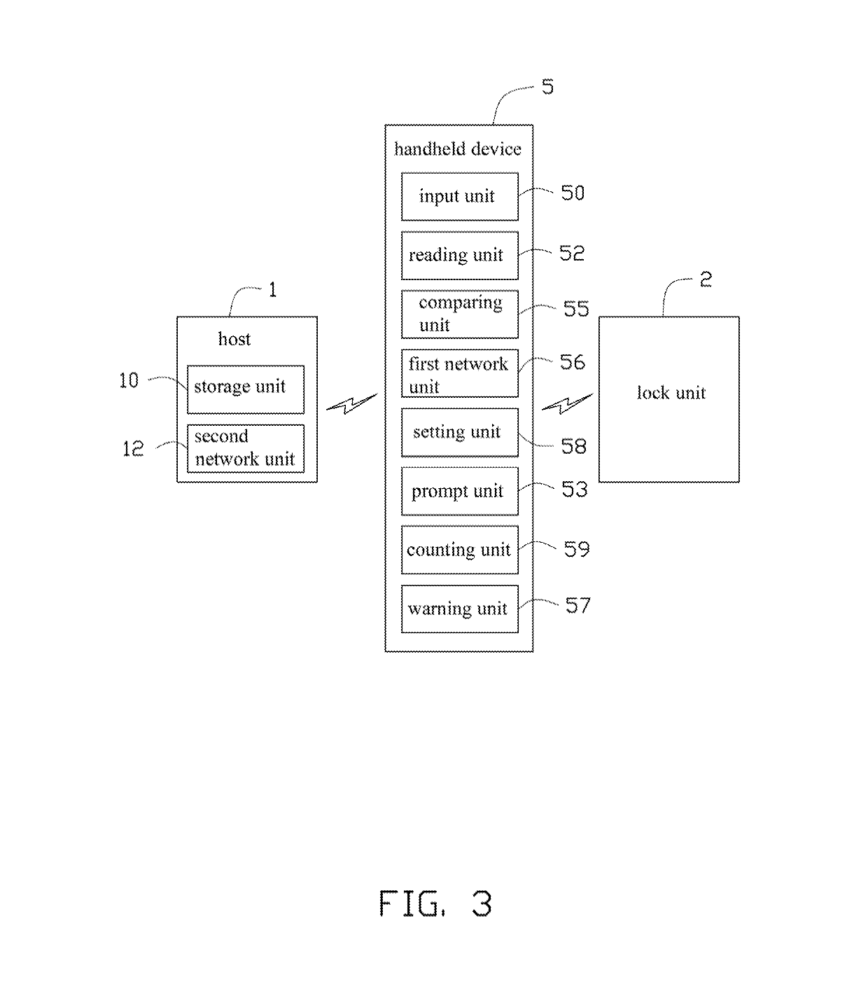

As shown in FIG. 3, the difference between the first and the third embodiments of the security system is the operating device. The operating device of the first embodiment is the human-computer interface 3 which may be fixed near the outside of the door while the operating device of the third embodiment is a handheld device 5 which can be carried around by the user. The functions of the human-computer interface 3 can be integrated into the handheld device 5, such as a cell phone or a Personal Digital Assistant (PDA) so that the number of things carried by the user would not be increased. The handheld device 5 includes an input unit 50, a reading unit 52, a comparing unit 55, a first network unit 56, a setting unit 58, a prompt unit 53, a counting unit 59 and a warning unit 57. In the embodiment, the input unit 50 can be a touch screen. The functions of the input unit 50, the reading unit 52, the comparing unit 55, the first network unit 56, the setting unit 58, the prompt unit 53, the counting unit 59 and the warning unit 57 are the same as the functions of the corresponding units in the first embodiment. Therefore, it is convenient for the user to set the predetermined password and input the user's password as required.

An operating method of the embodiment is described as follows:

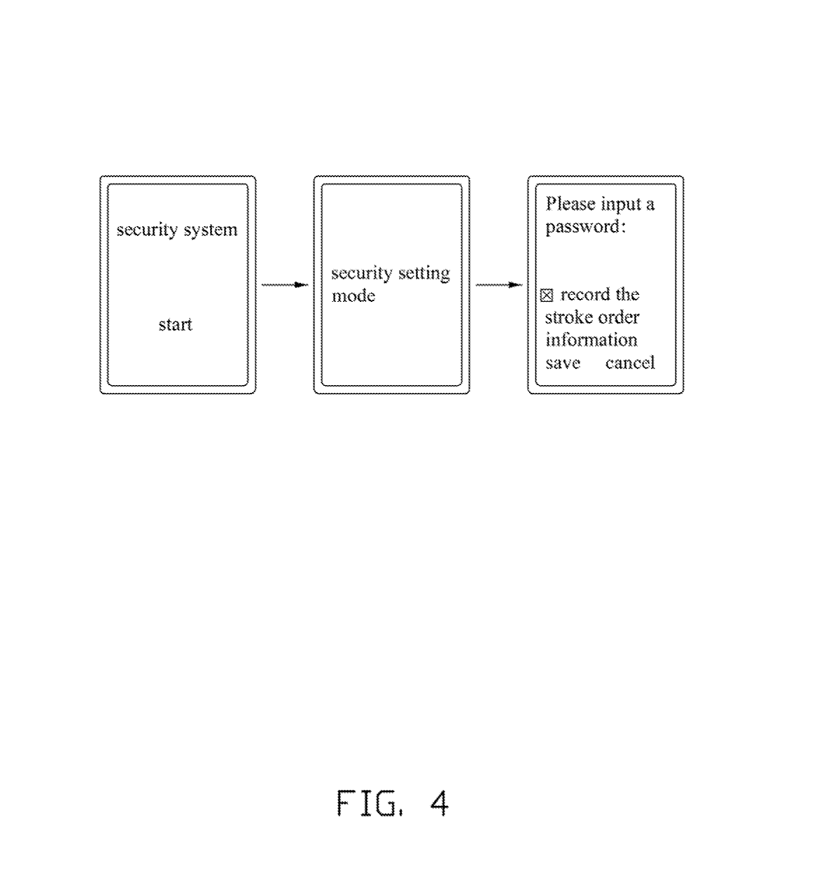

As shown in FIG. 4, the user selects the security setting mode first when the user wants to set the predetermined password by means of the handheld device 5. Then, the security system requests the user to input a password as a predetermined password and suggests to the user that the stroke order information of the predetermined password should be recorded. When the user inputs a password twice, the password is then predetermined and will be stored in the storage unit 10 by the communication between the first network unit 56 and the second network unit 12 of the host 1. Thereby, the user can finish the steps of setting the predetermined password. After that, the user can repeat the same steps to change the predetermined password. In particular, the user must input the old predetermined password before changing it to a new one. Similar steps for changing a predetermined password are well-known in related art so that the related steps are not further described in this disclosure.

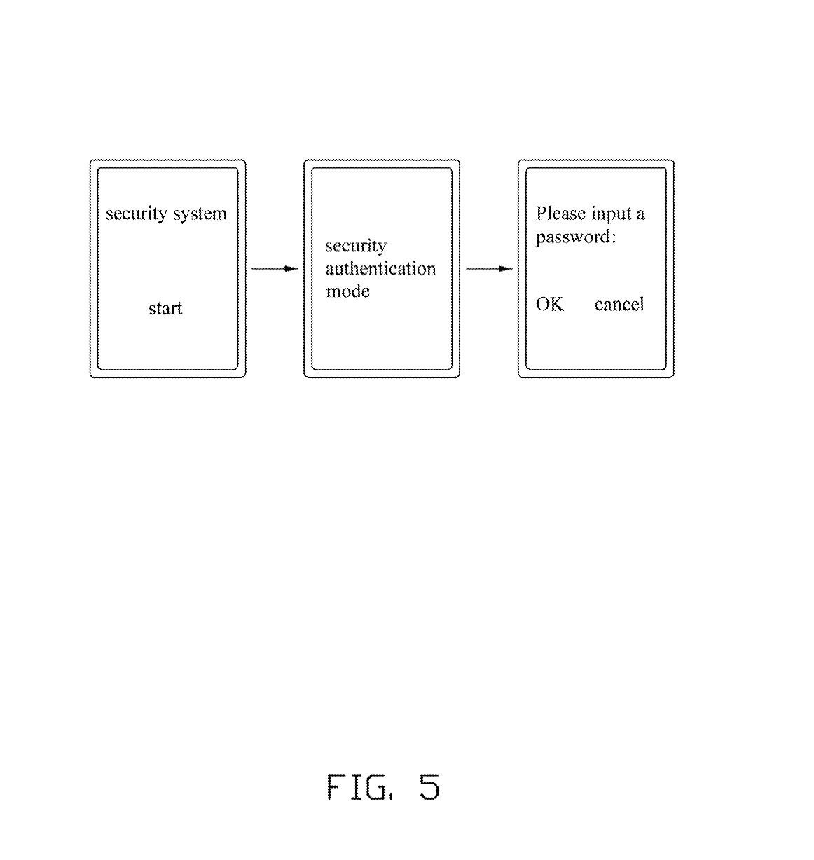

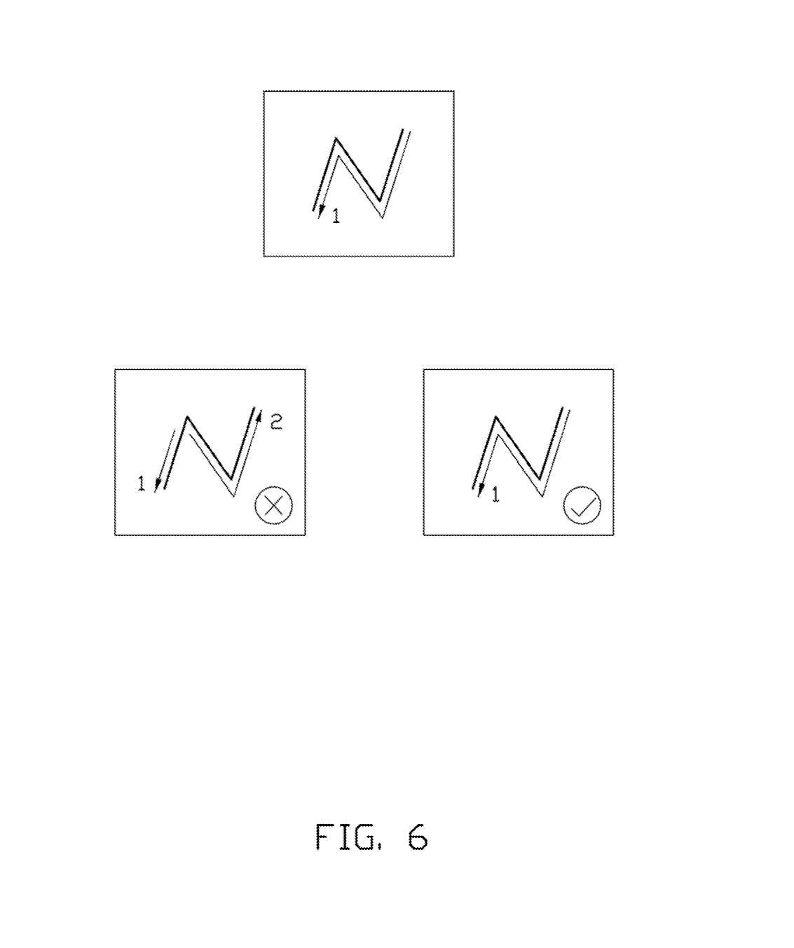

Then, the user will receive a request for inputting a password when the user selects the security authentication mode, as shown in FIG. 5. After the user inputs a password by means of the input unit 30, the reading unit 52 reads the predetermined password previously stored in the storage unit. Then, the comparing unit 55 compares the inputted password with the predetermined password to check whether the content and the stroke order information are the same. An example of a comparison between the two stroke order information is shown in FIG. 6.

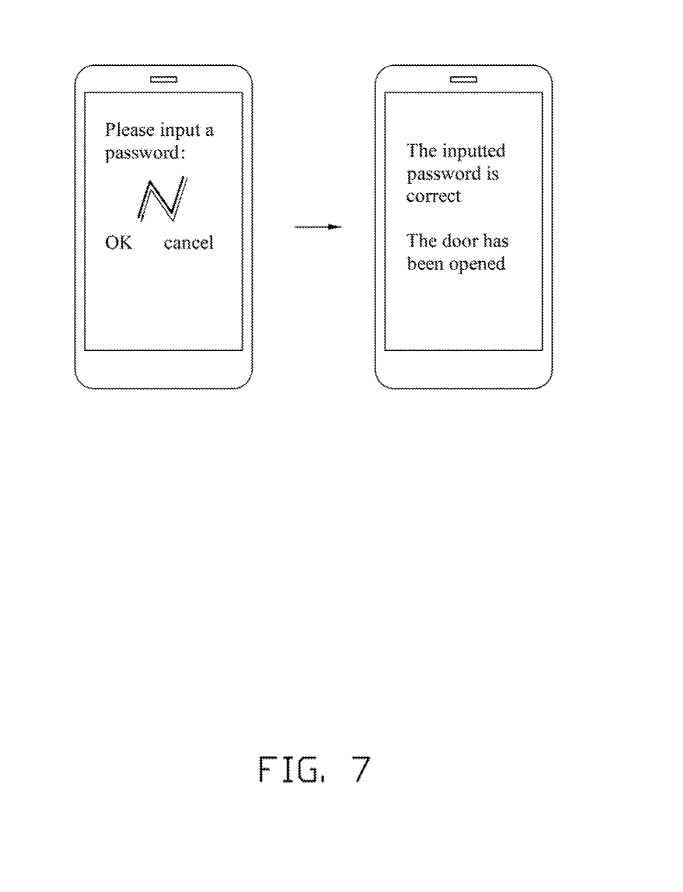

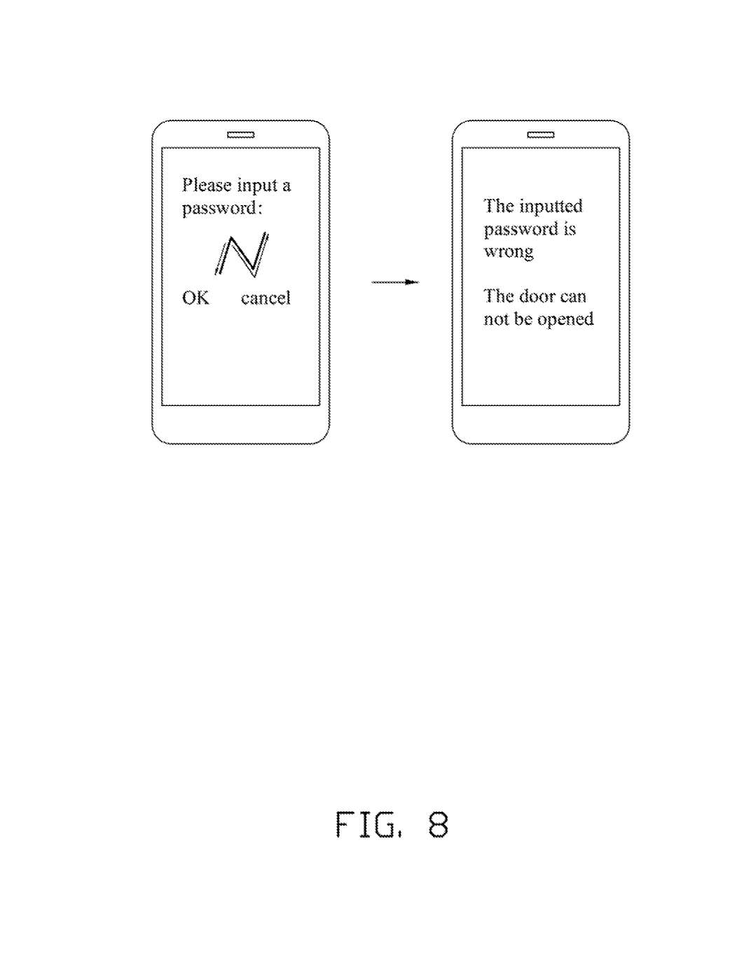

As shown in FIG. 7, the comparing unit 55 sends a first control signal to unlock the lock unit 2 when the inputted password matches the predetermined password. As shown in FIG. 8, the comparing unit 55 sends a second control signal to the prompt unit 53 to prompt that the inputted password is wrong and that the user should input another password again.

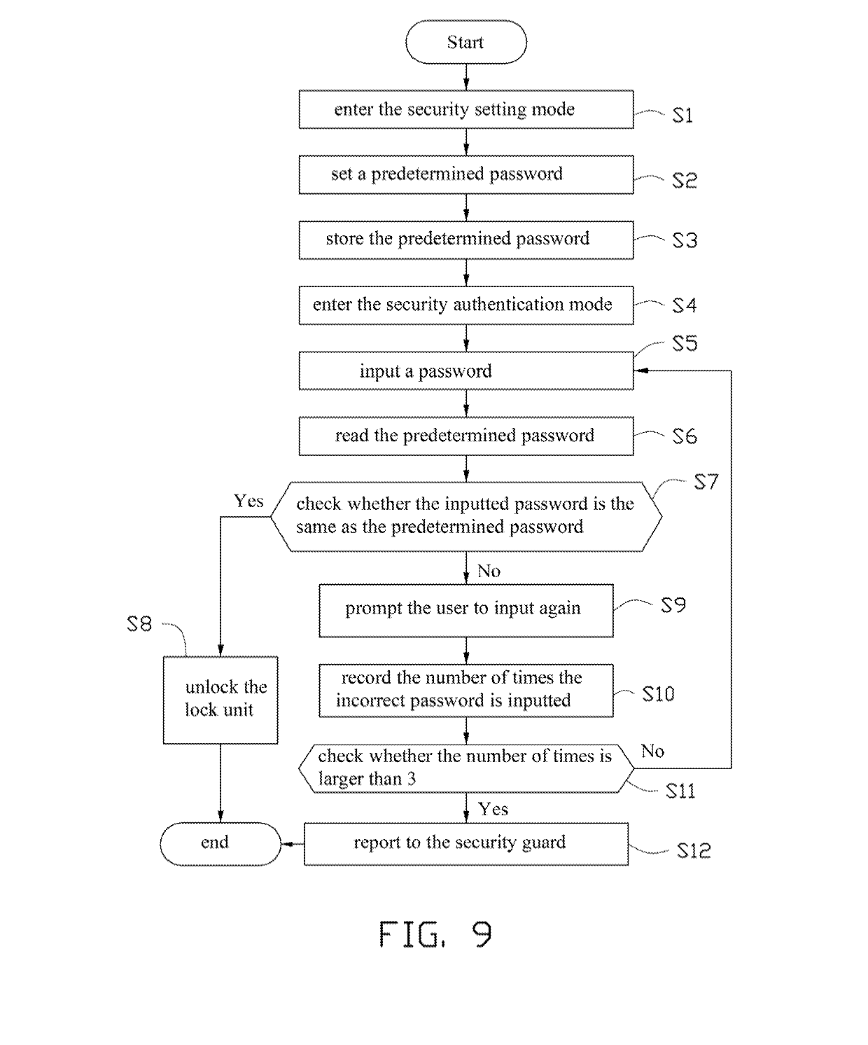

As shown in FIG. 9, an embodiment of the security method is as follows:

In step S1, the security setting mode is selected by the setting unit 58 according to the selection of the user.

In step S2, the user is invited to input a password as the set or predetermined password. At that time, the user can input by means of the input unit 30, such as the touch screen.

In step S3, the predetermined password is stored in the storage unit 10 of the host 1.

In step S4, the security authentication mode is selected by the setting unit 58 according to the selection of the user.

In step S5, the user is invited to input a password. At that time, the password can be inputted by means of the input unit 30.

In step S6, the reading unit 52 reads the predetermined password stored in the storage unit 10.

In step S7, the comparing unit compares the inputted password with the predetermined password to check whether or not the content information and the stroke order information of the inputted password are the same as the content information and the stroke order information of the predetermined password. If the content information and the stroke order information of the inputted password match the content information and the stroke order information of the predetermined password, the procedure goes to step S8. If the content information of the two passwords are different or the stroke order information of the two passwords are different, the procedure goes to step S9.

In step S8, the comparing unit 55 transmits a first control signal to unlock the lock unit 2 so that the user can open the door.

In step S9, the comparing unit 55 transmits a second control signal to the prompt unit 53 prompting the user to input another password again.

In step S10, the counting unit 59 records the number of times that the inputted password is different from the predetermined password.

In step S11, the counting unit 59 checks whether the number of times the incorrect password is inputted is larger than a predetermined number, such as three times. If the number of times is larger than three, the procedure goes to step S12. If the number of times is not larger than three, the procedure goes to step 5 and the user is invited to input another password again.

In step S12, the counting unit 59 transmits the third control signal to the warning unit 57. The warning unit 57 reports a security situation to the security guard of the house or to the user and the security guard at the same time by the first network unit 57 so that the security guard may go to check the door due to the security situation.

The above security system and method operate by using the human-computer interface 3 or the handhold device 5 for inputting a password and comparing the inputted password with the predetermined password. Then, the lock unit 2 is unlocked when the inputted password matches the predetermined password. Therefore, it is not at all necessary for the user to carry around an authentication instrument, such as a key or a card. In addition, the comparing unit 35 or 55 can compare the stroke order information of the two passwords so that the level of the security system can be very easily enhanced.

While the disclosure has been described by way of example and in terms of various embodiments, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A security system, comprising:
an input unit configured to input a password;
a storage unit configured to store a predetermined password, wherein both of the inputted password and the predetermined password comprise a content information and a stroke order information; and
a comparing unit configured to compare the inputted password with the predetermined password, wherein a lock unit is unlocked when the inputted password is identical with the predetermined password.

2. The security system of claim 1, further comprising:
a prompt unit configured to prompt to input another password again when the inputted password is different from the predetermined password;
a counting unit configured to count a number of times that the inputted password is different from the predetermined password; and
a warning unit configured to report a security situation when the number of times is larger than a predetermined number.

3. The security system of claim 1, further comprising:
a setting unit configured to choose a mode from a security authentication mode and a security setting mode, wherein the predetermined password is set in the security setting mode, and the inputted password is inputted in the security authentication mode; and
a reading unit configured to read the predetermined password stored in the storage unit.

4. The security system of claim 1, wherein the input unit is configured in an operating device and the operating device is one of a human-computer interface and a handheld device.

5. The security system of claim 4, wherein the storage unit is configured in a host and the host communicates with a first network unit of the operating device by a second network unit

6. The security system of claim 1, wherein the lock unit is configured to lock a door of a security area.

7. The security system of claim 6, wherein the security area comprises a plurality of controlled areas, each of the controlled area is corresponding to a corresponding storage unit.

8. The security system of claim 7, further comprising:
a choice unit configured to select one of the plurality of controlled areas.

9. The security system of claim 8, wherein the comparing unit compares the inputted password with the predetermined password stored in the corresponding storage unit of the selected controlled area.

10. The security system of claim 1, wherein the content information is one of a letter, a symbol, a word, a character, a drawing and a combination thereof.

11. A security method, comprising:
inputting a password;
reading a predetermined password, wherein both of the inputted password and the predetermined password comprise a content information and a stroke order information;
comparing the inputted password with the predetermined password; and
opening a lock unit when the inputted password is the same as the predetermined password.

12. The security method of claim 11, further comprising:
prompting to input another password again when the inputted password is different from the predetermined password.

13. The security method of claim 11, further comprising:
counting a number of times that the inputted password is different from the predetermined password; and
reporting a security situation when the number of times is larger than a predetermined number.

14. The security method of claim 11, wherein the lock unit is configured to lock a door of a security area.

15. The security method of claim 14, wherein the security area comprises a plurality of controlled areas, each of the controlled area is corresponding to a corresponding storage unit.

16. The security method of claim 15, further comprising:
selecting one of the plurality of controlled areas; and
reading the predetermined password stored in the corresponding storage unit of the selected controlled area.

17. A security system, comprising:
a plurality of storage units, each of the storage unit is configured to store a predetermined password, wherein the predetermined password comprises a first content information and a first stroke order information;
an input unit configured to input a password, wherein the inputted password comprises a second content information and a second stroke order information;
a choice unit configured to select one of the plurality of storage units; and
a comparing unit configured to compare the inputted password with the corresponding predetermined password stored in the selected storage unit, wherein a lock unit is opened when the inputted password is the same as the corresponding predetermined password.

18. The security system of claim 17, wherein the lock unit is configured to lock a door of a security area.

19. The security system of claim 18, wherein the security area comprises a plurality of controlled areas, each of the controlled area is corresponding to one of the plurality of storage units.

20. The security system of claim 17, wherein the inputted password is the same as the corresponding predetermined password when the second content information matches the first content information of the corresponding predetermined password and the second stroke order information matches the first stroke order information of the corresponding predetermined password.
